(19) United States
(12) Patent Application Publication
(10) Pub. No.: US 2014/0168121 A1
(43) Pub. Date: Jun. 19, 2014

(54) ELECTRONIC APPARATUS WITH HIDDEN SENSOR GUIDING INDICATION AND INSTINCTIVE GUIDING METHOD APPLIED TO SUCH APPARATUS

(71) Applicant: Bruce C.S. CHOU, Hsin Chu (TW)

(72) Inventor: Bruce C.S. CHOU, Hsin Chu (TW)

(21) Appl. No.: 14/105,686

(22) Filed: Dec. 13, 2013

(30) Foreign Application Priority Data
Dec. 19, 2012 (TW) 101148215

(51) Int. Cl. G06K 9/00; G06F 3/041

(52) U.S. Cl. CPC G06K 9/00013; G06F 3/041
USPC 345/173

(57) ABSTRACT

An electronic apparatus with a hidden sensor guiding indication includes a housing, a display, a biometrics sensor and a processor. The display is visually disposed in the housing. The biometrics sensor, hidden in the housing and disposed beside the display, senses a biometrics message of a user. The processor, disposed in the housing and electrically connected to the display and the biometrics sensor, controls operations of the display and the biometrics sensor. In a sensing mode, the processor controls the display to display a guiding message to instinctively guide the user to operate the hidden biometrics sensor, disposed beside the display, to sense the biometrics message. An instinctive guiding method is also disclosed.

This application claims priority of No. 101148215 filed in Taiwan R.O.C. on Dec. 19, 2012 under 35 USC 119, the entire content of which is hereby incorporated by reference.

### BACKGROUND OF THE INVENTION

1. Field of the Invention

The invention relates to an electronic apparatus with a hidden sensor guiding indication and an instinctive guiding method applied to such the apparatus.

2. Related Art

The electronic apparatus with a fingerprint sensor can provide the fingerprint identifying function and provide a more robust authentication method than the password authentication on the data security, and thus have the growing business opportunity in the market. However, under the limitation of the design principle of the sensing mechanism, the conventional fingerprint sensor needs to be mounted in an opening of the electronic apparatus to provide the sensing result with the proper sensitivity. Consequently, the intergration of the fingerprint sensor affects the outlook of the electronic apparatus.

Recently, the touch displays are getting more and more popularized, the outlook of the electronic apparatus is getting simpler and simpler because all functions can be operated through the touch display. However, the arrangement of the fingerprint sensor damages the beauty of the electronic apparatus, so that the manufacturers would consider not using the fingerprint sensor as the authentication mechanism, thereby narrowing the application range of the fingerprint sensor and decreasing the security of the authentication mechanism.

### SUMMARY OF THE INVENTION

It is therefore an object of the invention to provide an electronic apparatus with a hidden sensor guiding indication and an instinctive guiding method applied to such the electronic apparatus.

To achieve the above-identified object, the invention provides an electronic apparatus with a hidden sensor guiding indication. The electronic apparatus includes a housing, a display, a biometrics sensor and a processor. The display is visually disposed in the housing. The biometrics sensor is hidden in the housing and disposed beside the display and senses a biometrics message of a user. The processor is disposed in the housing, electrically connected to the display and the biometrics sensor, and controls operations of the display and the biometrics sensor. In a sensing mode, the processor controls the display to display a guiding message to instinctively guide the user to operate the hidden biometrics sensor, disposed beside the display, to sense the biometrics message.

In addition, the invention also provides an instinctive guiding method applied to an electronic apparatus, which includes a housing, a display and a biometrics sensor. The display is visually disposed in the housing. The biometrics sensor is hidden in the housing and disposed beside the display. The method includes the step of generating a guiding message in a sensing mode; and displaying the guiding message through the display to instinctively guide a user to operate the biometrics sensor, disposed beside the display, to sense a biometrics message of the user.

Because the biometrics sensor of the electronic apparatus of the invention is designed to be hidden, the user cannot see the location of the biometrics sensor from the outlook of the electronic apparatus, but can smoothly perform the biometrics message sensing through the guiding and indicating of the electronic apparatus. Consequently, the outlook of the electronic apparatus cannot be affected, and the trouble of the user in using the electronic apparatus cannot be caused. Thus, the invention provides a win-win biometrics sensing mechanism to effectively enhance the data security level of the electronic apparatus.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIGS. 1A to 1I are schematic illustrations showing electronic apparatuses according to first to ninth embodiments of the invention.

FIG. 2 is a schematic illustration showing an optical biometrics sensor module that can be applied to this invention.

FIG. 3 is a schematic illustration showing a capacitive biometrics sensor module that can be applied to this invention.

FIGS. 4A and 4B are schematic illustrations showing a structure and a circuit that can be used to implement the capacitive biometrics sensor module of FIG. 3.

### DETAILED DESCRIPTION OF THE INVENTION

The present invention will be apparent from the following detailed description, which proceeds with reference to the accompanying drawings, wherein the same references relate to the same elements.

At present, an electronic apparatus usually has a fingerprint sensor exposed outside. So, the designer of the electronic apparatus only needs to instruct the user to perform the fingerprint sensing using texts or voice in conjunction with an operation manual. In this invention, however, the fingerprint sensor is hidden in order to prevent the beauty of the electronic apparatus from being damaged. So, an ordinary user cannot recognize the position of the fingerprint sensor, and thus cannot correctly use the fingerprint sensor to perform the fingerprint sensing without reading the apparatus and the method of the invention.

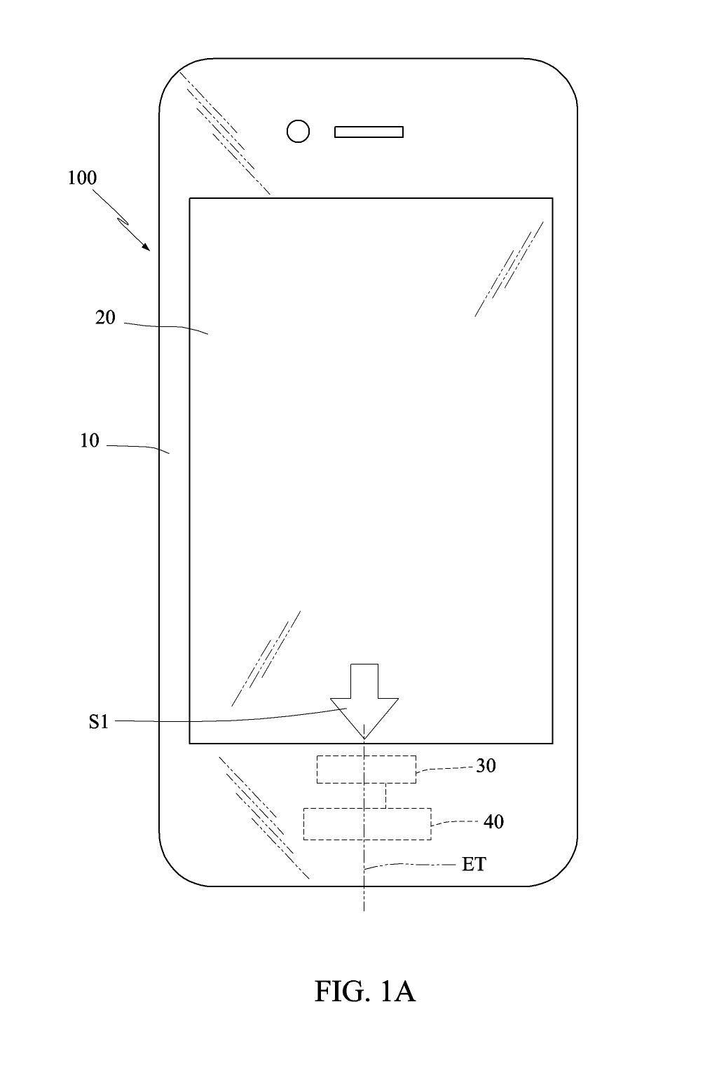

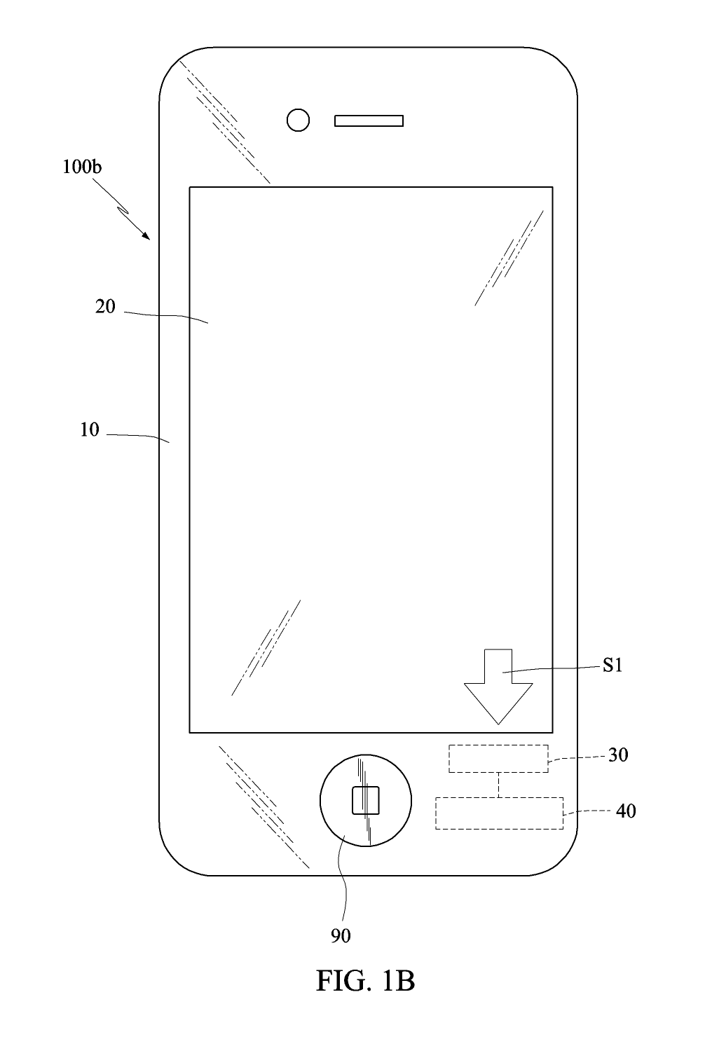

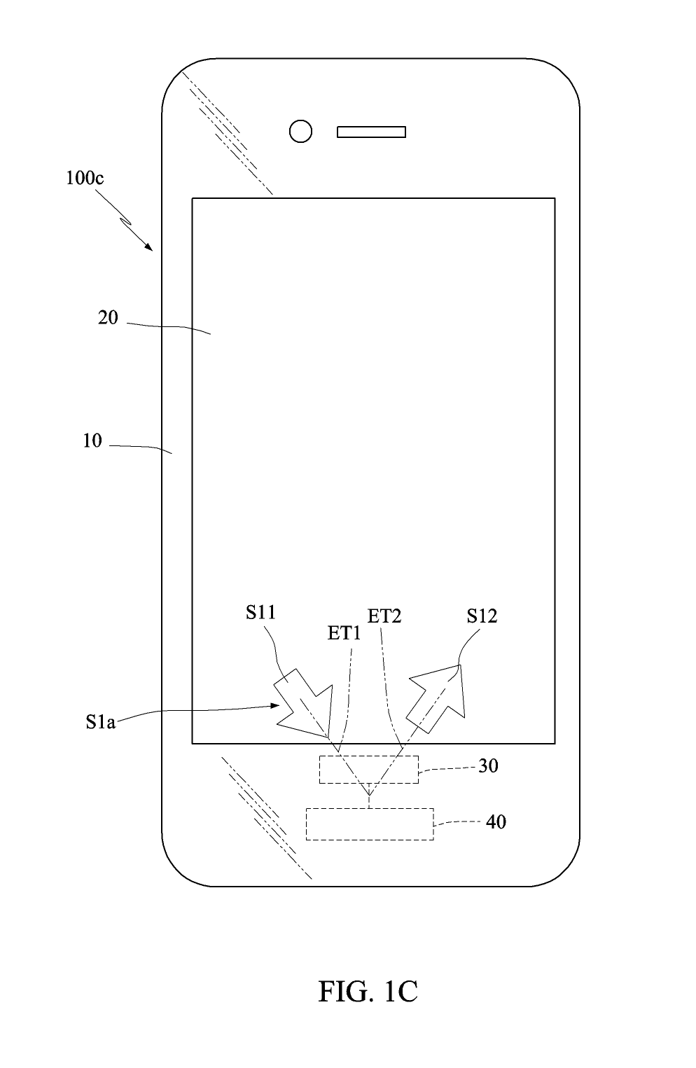

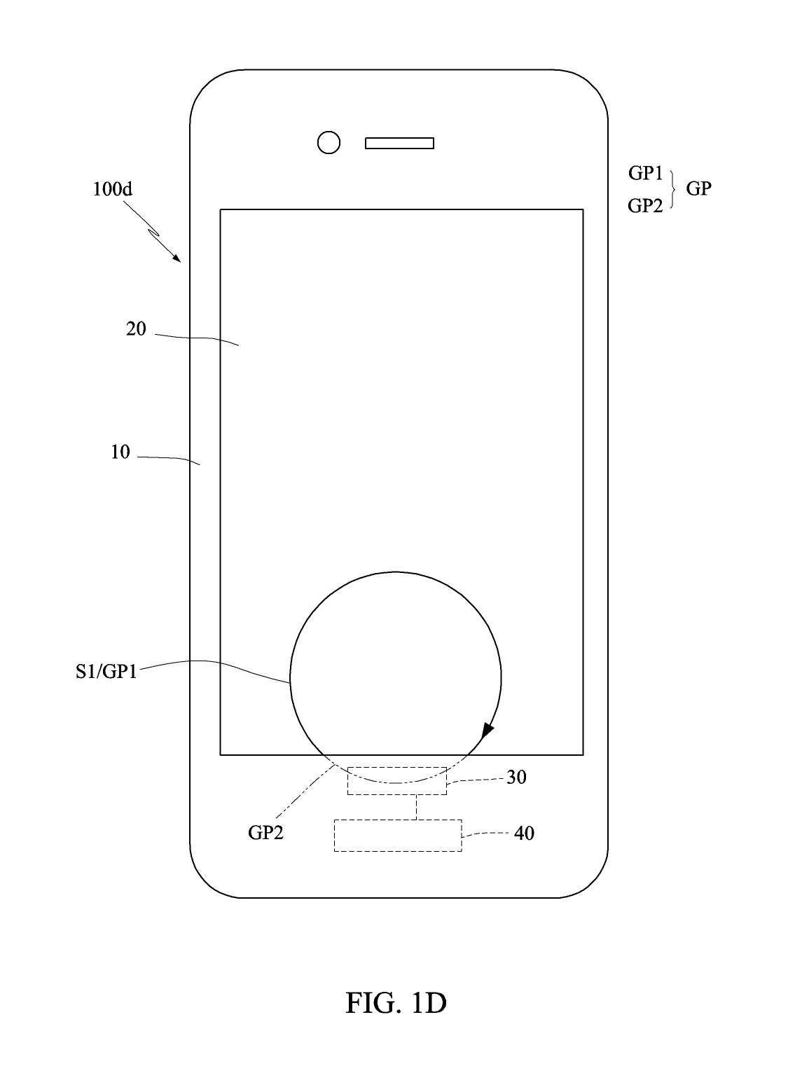

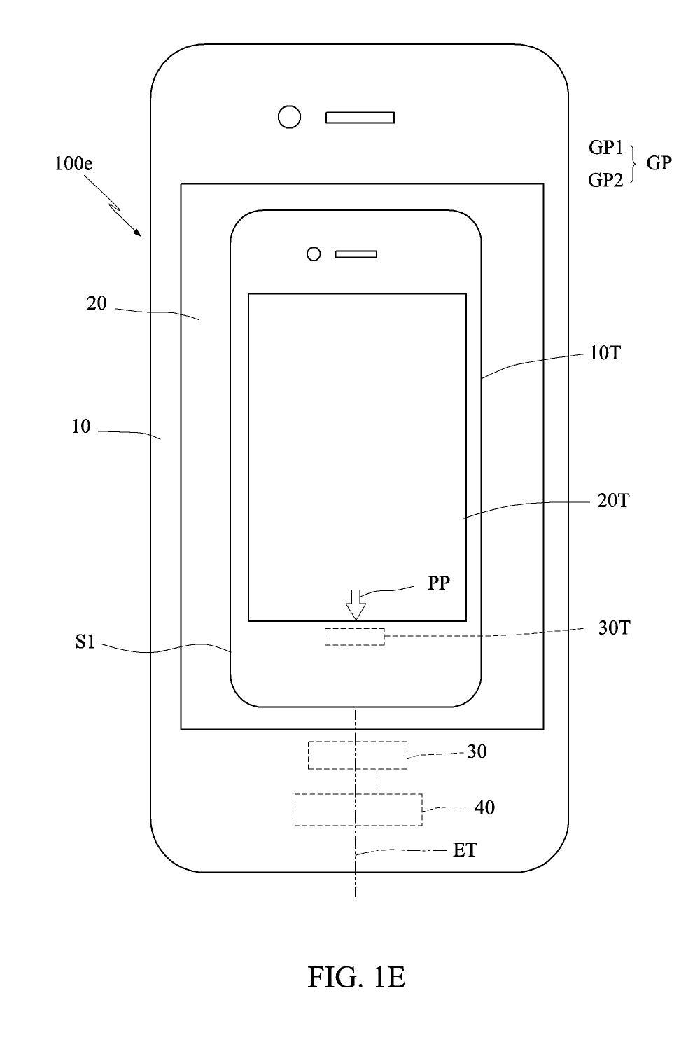

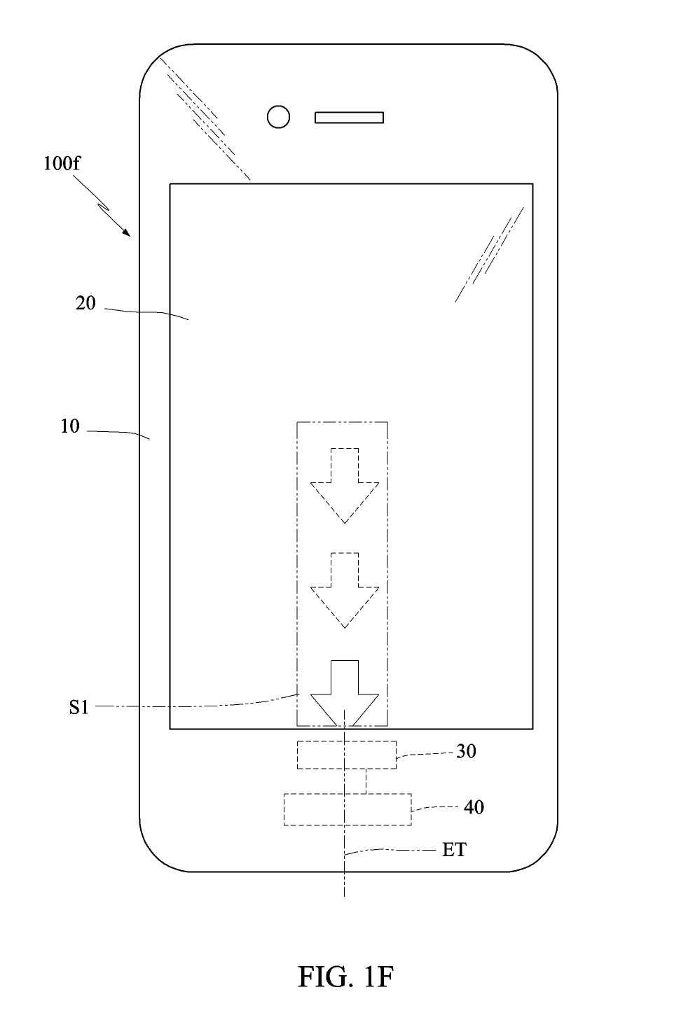

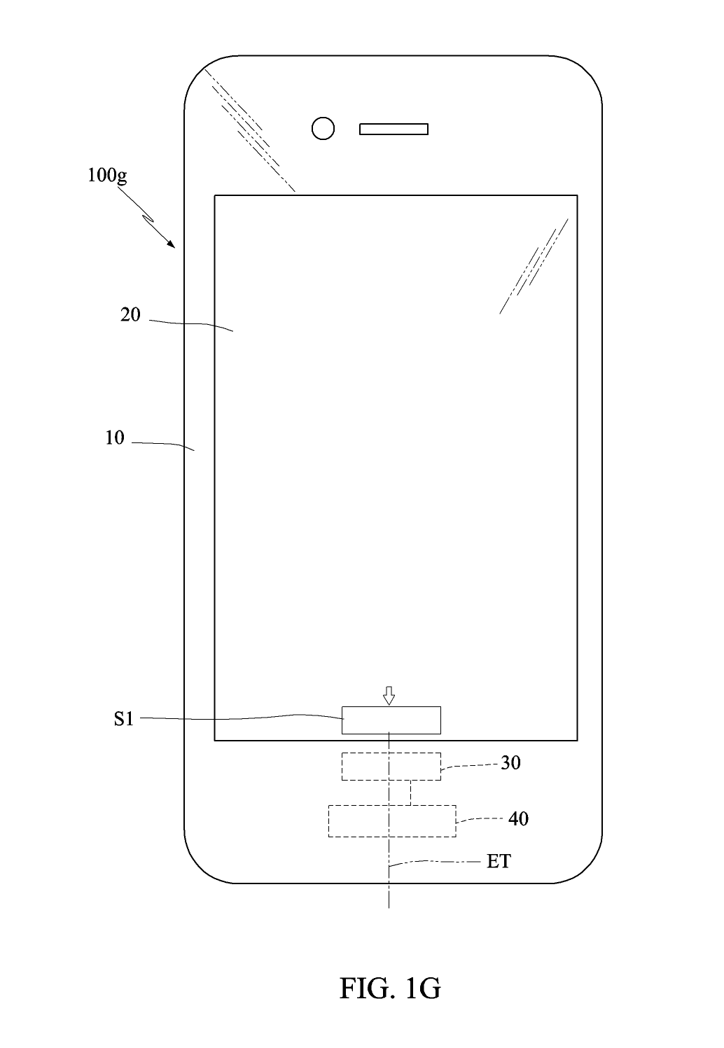

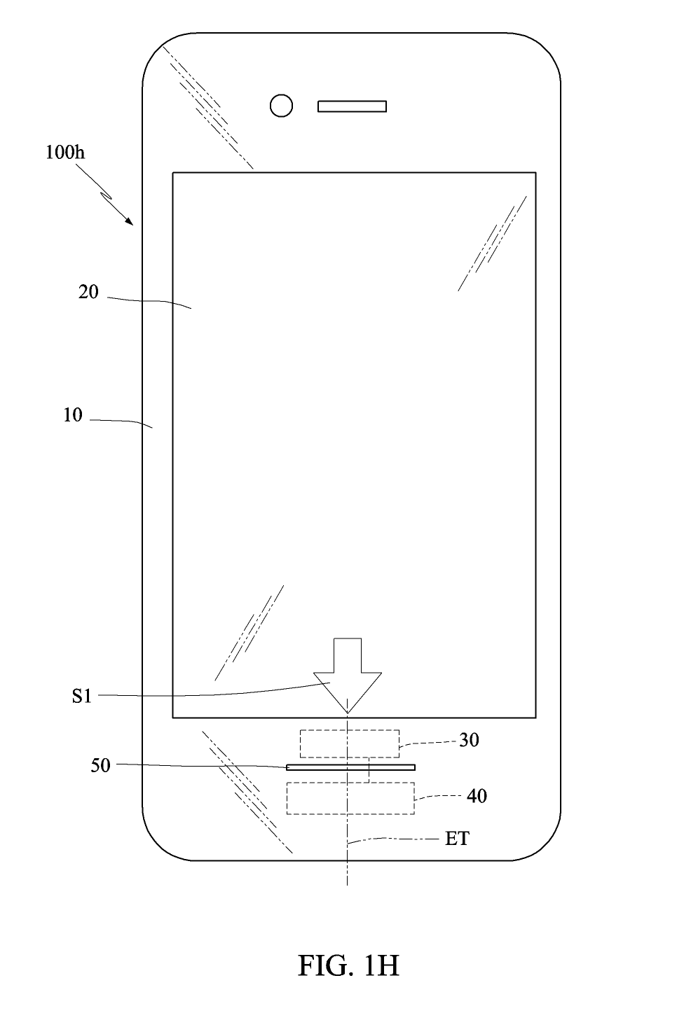

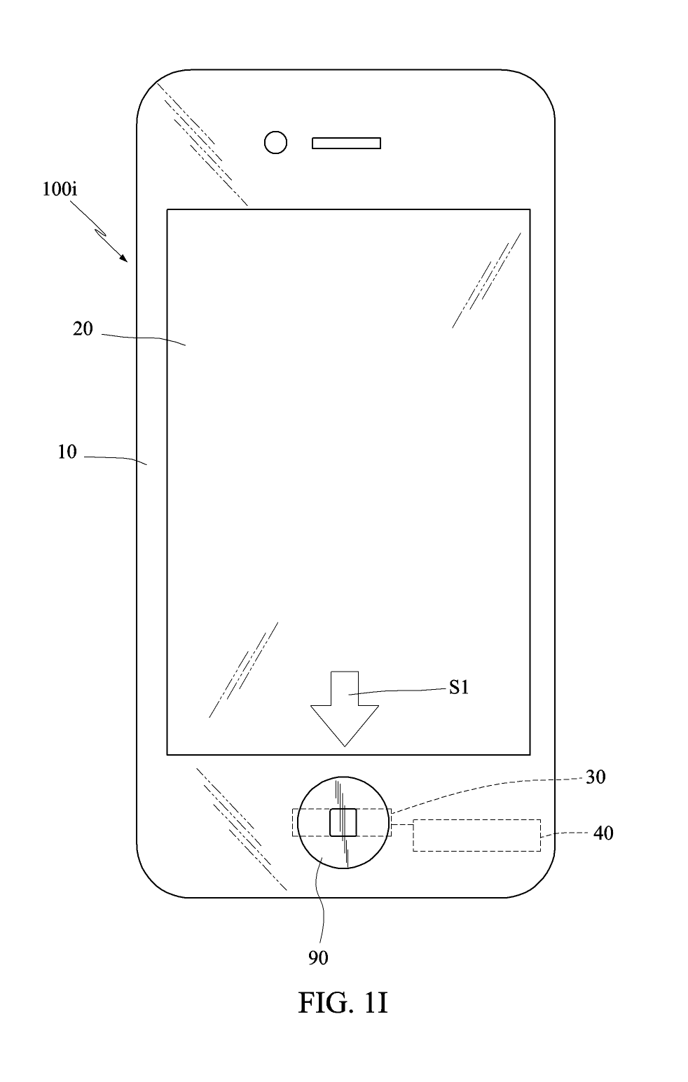

FIGS. 1A to 11 are schematic illustrations showing electronic apparatuses according to first to ninth embodiments of the invention.

As shown in FIG. 1A, an electronic apparatus 100 with the hidden sensor guiding indication according to the first embodiment includes a housing 10, a display 20, a biometrics sensor 30 and a processor 40.

The housing 10 is the outermost structure of the electronic apparatus 100 and is also a structure that can be held by the user's hand or hands. Many components are disposed in the housing 10. For example, the components, such as a mainboard (not shown), a camera lens (not shown), a battery (not shown), are disposed in the housing 10.

The display 20 is visually disposed in the housing 10. That is, the user can see the display 20. The display 20 also displays a frame or a message to interact with the user. The display 20 may be a liquid crystal display (LCD), an organic light-emitting diode display (OLED) or the like.

The biometrics sensor 30, hidden in the housing 10 and disposed beside the display 20, senses a biometrics message of a user. In this embodiment, the biometrics sensor 30 is described with reference to a fingerprint sensor in one example. However, in another example, the biometrics sensor 30 may also be an electric field fingerprint sensor or an optical fingerprint sensor, or an optical image sensor serving as a palmprint sensor, an iris sensor, a vein sensor or a face recognition sensor. The invention does not intend to particularly restrict the type of the sensor. In addition to the biometrics message representative of the presence or absence of the hand or fingers, the biometrics message is preferably the fingerprint message, palmprint message, vein distribution pattern message or the like.

The processor 40 disposed in the housing 10 is electrically connected to the display 20 and the biometrics sensor 30, and controls the operations of the display 20 and the biometrics sensor 30. In a sensing mode, the processor 40 controls the display 20 to display a guiding message S1 to instinctively guide the user to operate the hidden biometrics sensor 30, disposed beside the display, to sense the biometrics information. Of course, in a non-sensing mode, the processor 40 displays the associated message on the display 20 according to a user's request.

In one embodiment, the guiding message S1 includes a direction indicating frame (e.g., the arrow frame in the drawing). An extension line ET of a direction indicating pattern (the arrow in the drawing) of the direction indicating frame runs across (or intersects with) the biometrics sensor 30. The conditions include, for example but without limitation to, that the extension line ET runs across the sensing range of the biometrics sensor 30. This represents that, after the user sees this indication frame, the user can instinctively place his/her finger on or sweep the finger across the biometrics sensor 30. This is because that the direction indicating frame is disposed very close to the periphery of the display 20 and the biometrics sensor 30, and the housing 10 constitutes an all-flat plane covering the biometrics sensor 30 and the display 20. So, the user's action naturally (or inevitably) sweeps the finger across the display 20 and thus the biometrics sensor 30, or sweeps the finger across the display 20 and reaches the biometrics sensor 30, so that the biometrics sensor 30 can sense the fingerprint image of the user's finger. After the fingerprint image is sensed, the processor 40 further identifies the biometrics information, and enters an unlocked mode, in which an interaction frame is displayed on the display 20 to interact with the user, after the identification passes. If the identification fails, the locked mode is continuously kept or the user is requested to perform the sensing operation again. In order to make the user truly sweep his/her finger across the biometrics sensor 30, the guiding message S1 can utilize a pattern, patterns or texts to guide the user to sweep his/her finger from the inside of the housing on the display to the outside of the housing (i.e., from the top of the housing to the outside of the housing). Alternatively, the processor 40 may also output an audio prompt message through a speaker to assist in guiding the user to sweep his/her finger to the outside of the display.

In addition, the invention further provides an instinctive guiding method used in the electronic apparatus 100. The method includes the following steps. First, the guiding message S1 is generated in the sensing mode. Then, the guiding message S1 is displayed on the display 20 to instinctively guide the user to operate the hidden biometrics sensor 30, disposed beside the display, to sense the user's biometrics message.

As shown in FIG. 1B, the electronic apparatus 100b of the second embodiment is similar to the first embodiment except that the electronic apparatus 100b further includes a button 90 to be pressed by the user to achieve the function of operating the electronic apparatus 100b. In this case, the biometrics sensor 30 and the guiding message S1 are moved to one side of the button 90. Such a design is similar to the outlook design of the existing product, and the user becomes aware of the presence of the biometrics sensor 30.

As shown in FIG. 1C, the electronic apparatus 100c of the third embodiment is similar to the first embodiment except that the guiding message S1 of the electronic apparatus 100c includes two direction indicating frames (arrows), wherein the extension lines ET1 and ET2 of the direction indicating patterns of the two direction indicating frames run across the biometrics sensor 30. Consequently, the user may draw a “V-shaped” track to perform the fingerprint sensing. In addition to the two direction indicating frames, the guiding message S1 may also further include a text prompt message to indicate the user to draw a V-shaped track.

As shown in FIG. 1D, the electronic apparatus 100d of the fourth embodiment is similar to the first embodiment except that the guiding message S1 of the electronic apparatus 100d includes a portion GP1 of a geometric pattern GP, and the other portion GP2 of the geometric pattern GP, which runs across the biometrics sensor 30. That is, the guiding message S1 represents an arc section, and the user instinctively draws the other arc section according to the arc section so that the two arc sections constitute a circle and the finger can sweep across the biometrics sensor 30. In addition, the guiding message S1 may further include a text prompt message for indicating the user to draw a circular track. Thus, a more interesting guiding method can be provided to add the fun.

As shown in FIG. 1E, the electronic apparatus 100e of the fifth embodiment is similar to the first embodiment except that the guiding message S1 of the electronic apparatus 100e includes a thumbnail image frame, which includes scaled down patterns 10T, 20T and 30T of the housing 10, the display 20 and the biometrics sensor 30, and the relative position relationships therebetween. Thus, the user can instinctively recognize the location of the biometrics sensor 30 according to the thumbnail image patterns on the screen or display, and thus sweep the finger to perform the sweep sensing or stationary sensing. In addition, the thumbnail image frame may further include a prompt pattern PP for prompting the location or position of the biometrics sensor 30. The extension line ET of the prompt pattern PP also runs across the biometrics sensor 30.

As shown in FIG. 1F, the electronic apparatus 100f of the sixth embodiment is similar to the first embodiment except that the guiding message S1 of the electronic apparatus 100f includes an animation (or motion picture) frame (three arrows displayed sequentially flashing), and the extension line ET represented by the animation frame runs across the biometrics sensor 30. It is to be noted that the bottommost arrow is preferably incomplete so that the user instinctively feels to continuously sweep his/her finger downward to complete the arrow. Alternatively, the bottommost arrow may also be a complete arrow. In another example, the animation speed of the arrows may be increased to intentionally let the user's finger get the incapability of stopping immediately so that the finger accidentally or inevitably sweeps (or slides) across the biometrics sensor 30.

Regarding the sensing of the fingerprint of the finger, the biometrics sensor 30 is a sweep-type fingerprint sensor in this example, but may also be a non-sweep-type fingerprint sensor in another example.

As shown in FIG. 1G, the electronic apparatus 100g of the seventh embodiment is similar to the first embodiment except that the biometrics sensor 30 of this embodiment is a sweep-type fingerprint sensor, for example. In this case, a virtual sensor image (the image represented by S1) may even be displayed in the region of the display 20 neighboring the fingerprint sensor 30 to guide the user to sweep or slide his/her finger across this virtual sensor, and thus naturally or inevitably across the real hidden biometrics sensor 30. Thus, the guiding message S1 in this embodiment includes a virtual biometrics sensor (with no physical sensing function) for guiding the user to sweep his/her finger across the virtual biometrics sensor as well as the biometrics sensor 30. It is to be noted that the guiding message S1 itself may also include a blinking or specially displayed window, or the arrows shown in FIG. 1G.

As shown in FIG. 1H, the electronic apparatus 100h of the eighth embodiment is similar to the first embodiment except that a light-emitting unit (e.g., a light-emitting diode (LED)) 50 coordinating with the shape of the sensor 30 may be disposed beside the hidden biometrics sensor 30 in this embodiment. For example, the light-emitting unit 50 may be disposed in a linear manner to represent the sweep-type sensor, and in a rectangular manner to represent the area-type sensor (non-sweep-type sensor). According to the guiding message S1, it is possible to make the user place his/her finger, for example, on the hidden sensor 30 or sweep his/her finger across the hidden sensor 30. The linear light-emitting unit may represent the place where the finger must slide, and the rectangular light-emitting unit represents that the finger must be placed in the rectangular frame. Therefore, the electronic apparatus 100h further includes the light-emitting unit 50, which is disposed beside the biometrics sensor 30 and outputs light rays to perform auxiliary guiding.

As shown in FIG. 11, the electronic apparatus 100i of the ninth embodiment is similar to the second embodiment except that the biometrics sensor 30 of this embodiment is disposed under or below the button 90 and thus hidden. In this case, the electronic apparatus 100i further includes the button 90 disposed on the housing 10, wherein the biometrics sensor 30 is disposed below the button 90. The guiding message S1 may include the message for guiding the user to place his/her finger on the button 90 or to sweep his/her finger across the button 90. Thus, the button 90 has the functions of controlling the operations and sensing the biometrics message of the finger.

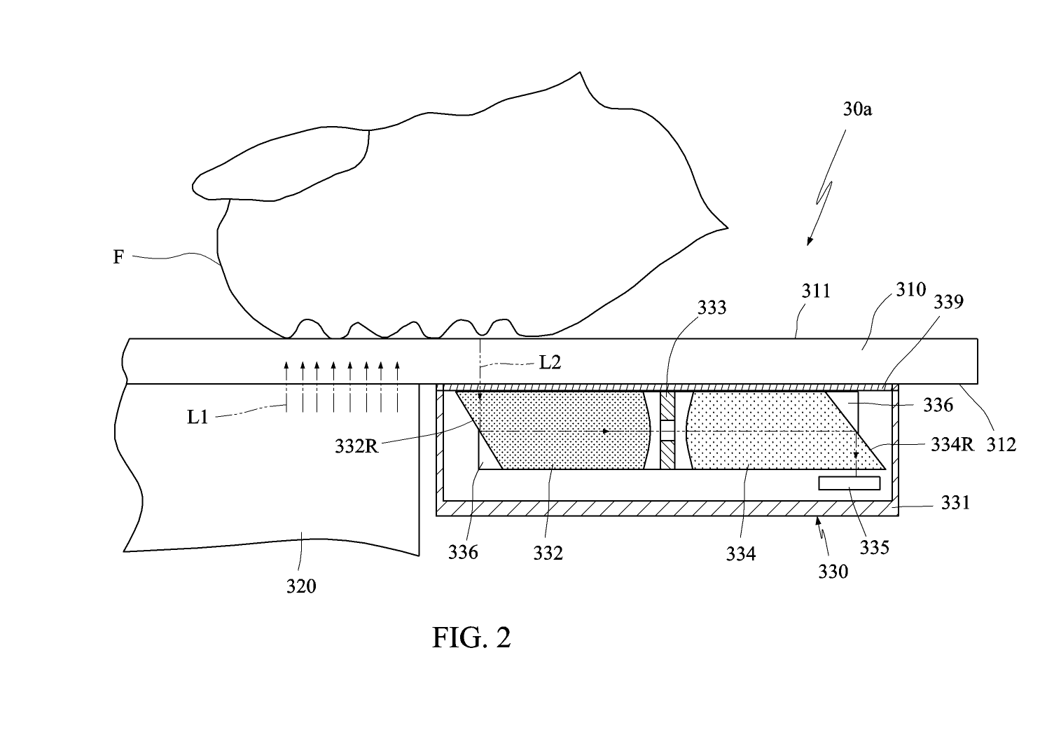

FIG. 2 is a schematic illustration showing an optical biometrics sensor module that can be applied to this invention. As shown in FIG. 2, this stray-light-coupled biometrics sensor module 30a includes a transparent body 310, a display unit 320 and an optical module 330. The transparent body 310 is equivalent to a portion of the housing 10 of FIG. 1A.

The transparent body 310 has a front side 311 and a backside 312, and the front side 311 is configured to support an object F thereon. The display unit 320 is mounted on the backside 312 of the transparent body 310 and displays a frame. The optical module 330 is mounted on the backside 312 of the transparent body 310 through a coupling adhesive 339, and disposed adjacent to the display unit 320. First light rays L1 of the frame couple into the object F through the transparent body 310. After travelling a short distance in the object F, the first light rays L1 couple out of the object F and become second light rays L2, which enter the optical module 330 through the transparent body 310. The optical module 330 senses the second light rays L2 to generate a biometrics image signal.

As shown in FIG. 2, the optical module 330 includes a housing 331 and a first waveguide 332, a second waveguide 334 and an optical image sensor 335, all of which are disposed in the housing 331. A connecting element 336 connects the first waveguide 332 to the second waveguide 334 so that the relative position between the first waveguide 332 and the second waveguide is fixed. The second light rays L2 sequentially pass through the first waveguide 332 and the second waveguide 334, and enter the optical image sensor 335 so that the biometrics image signal is generated. The optical image sensor 335 may be a charge-coupled device (CCD) image sensor, a complementary metal oxide semiconductor (CMOS) image sensor or the like. The first waveguide 332 and the second waveguide 334 may be solid waveguides or hollow waveguides, and will not be particularly restricted. The first waveguide 332 has a reflective surface 332R. The second waveguide 334 has a reflective surface 334R. The reflective surface 332R/334R can turn the travelling direction of the light rays by 90 degrees, for example, for the purpose of optical layout. In addition, the optical module 330 may further include a pupil 333, which is disposed between the first waveguide 332 and the second waveguide 334 and functions to filter out the stray light of the non-sensing signal so that the optical image sensor 335 has the better sensing quality.

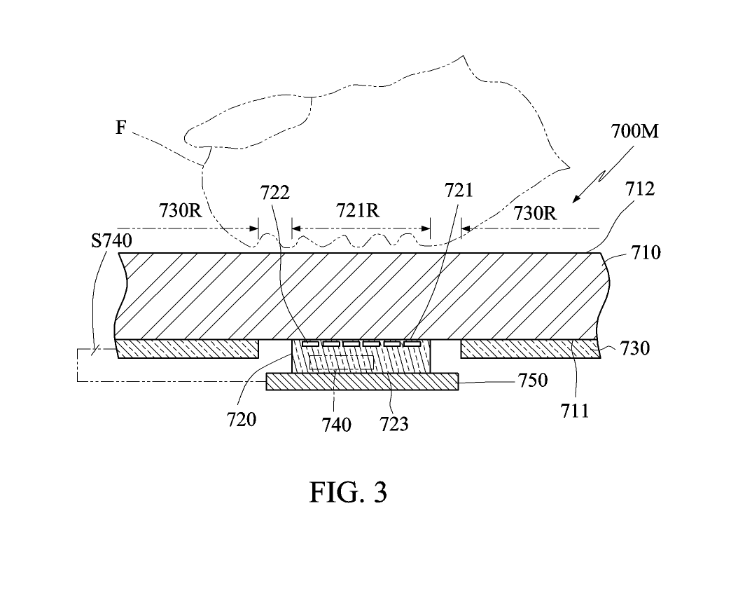

FIG. 3 is a schematic illustration showing a capacitive biometrics sensor module 700M that can be applied to this invention. Referring to FIG. 3, the biometrics sensor module 700M includes a housing 710, a biometrics sensor 720 and a coupling electrode 730. The housing 710 is equivalent to a portion of the housing 10 of FIG. 1A, and has a first surface 711 and a second surface 712 opposite to each other.

The biometrics sensor 720 has a sensing surface 721, which is disposed on the first surface 711 of the sensing surface 721, and has sensing members 722 arranged in an array. The coupling electrode 730 is disposed on the first surface 711 or the second surface 712 of the housing 710. Two regions 721R and 730R, projected from the sensing surface 721 and the coupling electrode 730 to the second surface 712 of the housing 710, do not overlap with each other. In this embodiment, the first surface 711 above the sensing surface 721 is not shielded by the coupling electrode 730. The coupling electrode 730 only provides a coupling signal S740 directly coupled to the object F. The finger F disposed above the sensing surface 721 cannot be shielded by the coupling electrode 730 to prevent the sensing from being affected.

In one example, an indium tin oxide (ITO) may be formed on the first surface 711 to form a transparent electroconductive film. In other embodiments, other materials with the electroconductive property may also be adopted to form the coupling electrode 730. A coupling signal S740 may be provided from a drive circuit 740 to the coupling electrode 730 and be directly or indirectly coupled to the object F, so that the sensing members 722 of the biometrics sensor 720 sense biometrics messages of the object F contacting with the second surface 712 of the housing 710. In this embodiment, the drive circuit 740 is disposed in the biometrics sensor (sensing chip) 720; while in another embodiment, the drive circuit 740 may be disposed independently (i.e., disposed outside the biometrics sensor 720 and being coupled to the coupling electrode 730), or may be integrated with other ICs to form a driver IC for a display, for example. Meanwhile, the sensing principle of the sensing chip of the invention is similar to that of the touch panel, so the sensing chip and the touch panel IC may be integrated into a single chip, the sensing chip and the display driver IC may be integrated into a single chip, or the sensing chip, the display driver IC and the touch panel IC may be integrated into one single chip.

In addition, the capacitive biometrics sensor module 700M of this embodiment further includes a flexible circuit board 750. The flexible circuit board 750 is directly electrically connected to the biometrics sensor 720 and is directly or indirectly electrically connected to the coupling electrode 730. A non-sensing surface 723 of the biometrics sensor 720 disposed opposite the sensing surface 721 is mounted on the flexible circuit board 750. The non-sensing surface 723 does not have the function of sensing the biometrics characteristic pattern of the object.

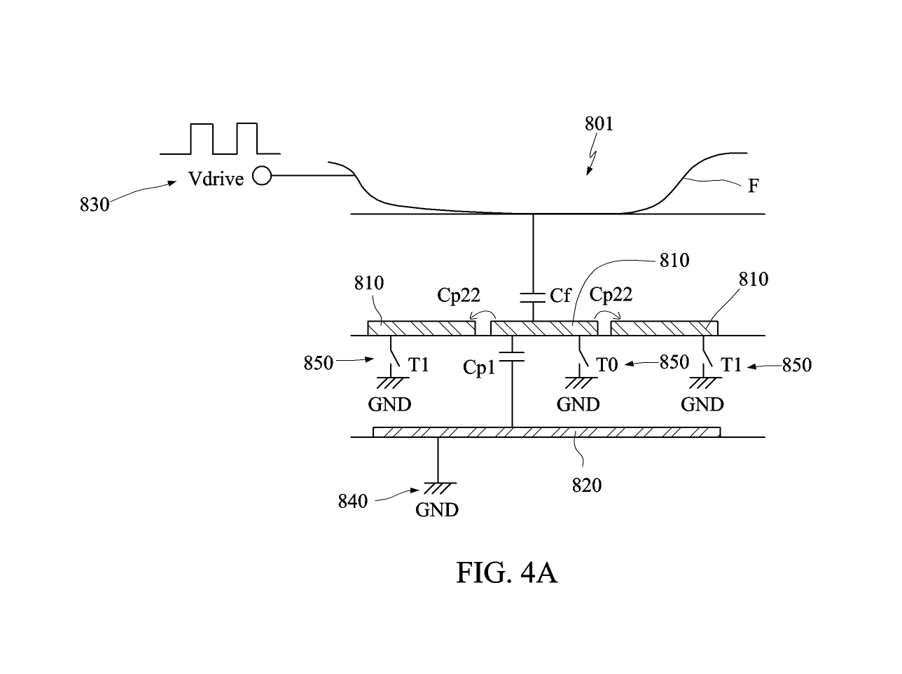

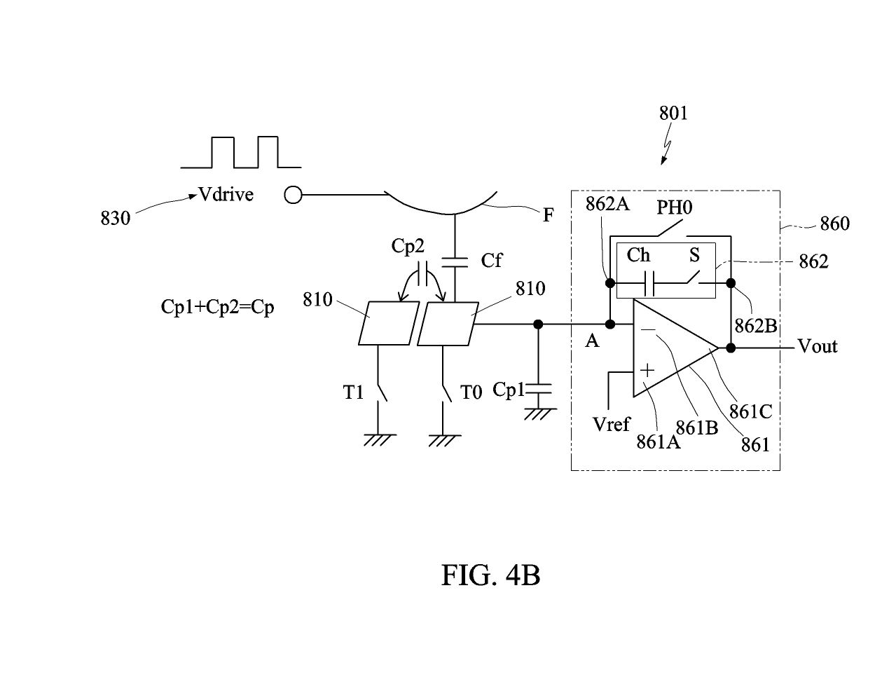

FIGS. 4A and 4B are schematic illustrations showing a structure and a circuit that can be used to implement the capacitive biometrics sensor module of FIG. 3. As shown in FIGS. 4A and 4B, the capacitive biometrics sensor module 801 includes sensing electrodes 810, a shielding conductor layer 820, a coupling signal source 830, a constant voltage source 840 and switch modules 850. These switch modules 850 are shown in FIGS. 4A and 4B and only represented by T0 and T1. When the middle sensing electrode 810 is selected to perform the sensing, the switch module TO turns off (in an open-circuited state), and the switch module T1 turns on (in a short-circuited state).

The sensing electrodes 810 are separately arranged in an array, wherein each sensing electrode 810 and the object F form a sense capacitor Cf. The shielding conductor layer 820 is disposed below the sensing electrode 810. The coupling signal source 830 provides a coupling signal Vdrive coupled to the object F. The constant voltage source 840 provides a constant voltage (a grounding voltage GND is described in this example, but another voltage may also be used in another example) to the shielding conductor layer 820, so that a stable vertical parasitic capacitor Cpl is formed between the shielding conductor layer 820 and each sensing electrode 810. The switch modules 850 are electrically connected to the sensing electrodes 810 in a one-to-one manner and electrically connected to the constant voltage source 840. When one of the sensing electrodes 810 is selected to perform the sensing, the switch modules 850 are set such that the selected sensing electrode 810 is disconnected from the constant voltage source 840, and the other sensing electrodes 810 are electrically connected to the constant voltage source 840, so that a stable horizontal parasitic capacitor Cp22 is formed between the selected sensing electrode 810 and the other sensing electrodes 810.

Referring to FIG. 4B, the capacitive biometrics sensor module 801 may further include multiple read circuits 860, which are electrically connected to the sensing electrode 810, and output multiple output signals Vout, respectively. In this application example, in order to prevent the signal transmission distance of each sensing electrode from getting too long and thus to prevent the signal from being affected, each sensing member is configured to have an operational amplifier, which is connected to the sensing electrode and amplifies the sense signal on the spot. Thus, the interference caused by the too long transmission cable can be eliminated. Therefore, each read circuit 860 includes an operational amplifier 861, a tunable capacitor 862 and a reset switch PH0.

The operational amplifier 861 may be entirely or partially formed under the sensing electrode(s) 810, and one sensing electrode 810 may correspond to one operational amplifier 861. Of course, multiple sensing electrodes 810 may correspond to one operational amplifier 861. The operational amplifier 861 has a positive input terminal 861A, a negative input terminal 861B and an output terminal 861C, wherein the negative input terminal 861B is electrically connected to the sensing electrode 810, and the positive input terminal 861A is electrically connected to a reference voltage Vref. The tunable capacitor 862 has a first terminal 862A electrically connected to the negative input terminal 861 B, and a second terminal 862B electrically connected to the output terminal 861 C. In this example, the tunable capacitor 862 is composed of a capacitor Ch and a switch S. In this example, since only one capacitor Ch is provided, the switch S can be eliminated. The reset switch PH0 is connected to the tunable capacitor 862 in parallel.

According to the circuit diagram of FIG. 4B, the output signal Vout may be derived according to the electrical charge conservation principle.

When Vdrive=0, the reset switch PH0 is in the short-circuited state, and the charge Q1 at the node A may be represented by:

Q1=Cf×(Vref−Vdrive)+Cp×Vref=Cf×Vref+Cp×Vref.

When Vdrive is high, the reset switch PH0 is in the open-circuited state, and the charge Q2 at the node A may be represented by:

Q2=Cf×(Vref−Vdrive)+Cp×Vref+Ch×(Vref−Vout).

According to the electrical charge conservation principle, Q1=Q2 may be obtained.

That is,

Cf×Vref+Cp×Vref=Cf×Vref−Cf×Vdrive+Cp×Vref+Ch×Vref−Ch×Vout.

The expression may be simplified as:

Cf×Vdrive−Ch×Vref=−Ch×Vout.

Then, it is obtained:

Vout=Vref−(Cf/Ch)×Vdrive,

wherein Cp=Cp1+Cp2. According to the above-mentioned equation, it is found that the output signal Vout does not relate to the parasitic capacitors Cp1 and Cp2. As mentioned hereinabove, the feature of the application example of the invention is to stabilize the fluctuating value of the parasitic capacitor, which fluctuates due to the uncontrolled surrounding environment, so that the parasitic capacitor may be naturally neglected under the operation principle of the operational amplifier sensing circuit. In addition, Cf/Ch is a gain. In the practical design, Ch is as small as possible because the sensing signal may be amplified in each independent sensing member so that the sensing signal cannot be interfered in the transmission line to affect the signal quality. In one application example of the invention, Vdrive is equal to 3.3V, Vref is equal to 1.8V, and Ch ranges from 1 to 4 fF. However, the invention is not particularly restricted thereto.

As mentioned herein, it is proved that the electronic apparatus with the hidden sensor according to the invention may be implemented.

Because the biometrics sensor of the electronic apparatus of the invention is designed to be hidden, the user cannot see the location of the biometrics sensor from the outlook of the electronic apparatus, but can smoothly perform the biometrics message sensing through the guiding and indicating of the electronic apparatus. Consequently, the outlook of the electronic apparatus cannot be affected, and the trouble of the user in using the electronic apparatus cannot be caused. Thus, the invention provides a win-win biometrics sensing mechanism to effectively enhance the data security level of the electronic apparatus.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An electronic apparatus with a hidden sensor guiding indication, the electronic apparatus comprising:
a housing;
a display visually disposed in the housing;
a biometrics sensor, which is hidden in the housing and disposed beside the display and senses a biometrics message of a user; and
a processor, which is disposed in the housing, electrically connected to the display and the biometrics sensor, and controls operations of the display and the biometrics sensor, wherein in a sensing mode, the processor controls the display to display a guiding message to instinctively guide the user to operate the hidden biometrics sensor, disposed beside the display, to sense the biometrics message.

2. The electronic apparatus according to claim 1, wherein the guiding message comprises a direction indicating frame, and an extension line of a direction indicating pattern of the direction indicating frame runs across the biometrics sensor.

3. The electronic apparatus according to claim 1, wherein the guiding message comprises two direction indicating frames, and extension lines of direction indicating patterns of the two direction indicating frames run across the biometrics sensor.

4. The electronic apparatus according to claim 1, wherein the guiding message comprises a portion of a geometric pattern, and the other portion of the geometric pattern runs across the biometrics sensor.

5. The electronic apparatus according to claim 1, wherein the guiding message comprises a thumbnail image frame, which comprises scaled down patterns and relative position relationships of the housing, the display and the biometrics sensor.

6. The electronic apparatus according to claim 5, wherein the thumbnail image frame further comprises a prompt pattern, which prompts a position of the biometrics sensor.

7. The electronic apparatus according to claim 1, wherein the guiding message comprises an animation frame, and an extension line represented by the animation frame runs across the biometrics sensor.

8. The electronic apparatus according to claim 1, wherein the biometrics sensor is a sweep-type fingerprint sensor.

9. The electronic apparatus according to claim 1, wherein the processor further identifies the biometrics message, and enters an unlocked mode to display an interaction frame on the display to interact with the user after the identification passes.

10. The electronic apparatus according to claim 1, wherein the guiding message guides a finger of the user to swipe from an inside of the housing, disposed on the display, to an outside of the housing.

11. The electronic apparatus according to claim 1, wherein the guiding message comprises a virtual biometrics sensor for guiding a finger of the user to sweep across the virtual biometrics sensor and the biometrics sensor.

12. The electronic apparatus according to claim 1, further comprising a light-emitting unit, which is disposed beside the biometrics sensor and outputs light rays to perform auxiliary guiding.

13. The electronic apparatus according to claim 1, further comprising:
a button disposed on the housing, wherein the biometrics sensor is disposed under the button.

14. An instinctive guiding method used in an electronic apparatus, the electronic apparatus comprising a housing, a display and a biometrics sensor, the display being visually disposed in the housing, the biometrics sensor being hidden in the housing and disposed beside the display, the method comprising the steps of:
generating a guiding message in a sensing mode; and
displaying the guiding message through the display to instinctively guide a user to operate the biometrics sensor, disposed beside the display, to sense a biometrics message of the user.
